(19) United States
(12) Patent Application Publication
(10) Pub. No.: US 2026/0118145 A1
(43) Pub. Date: Apr. 30, 2026

(54) PROCESSING BOARD AND ASSOCIATED SENSOR

(71) Applicant: Aktiebolaget SKF, Goteborg (SE)

(72) Inventors: Charlotte VU, Parcay Meslay (FR); Clément POULAILLEAU, Amboise (FR); Jean-Baptiste SAVATIER, Tours (FR)

(73) Assignee: Aktiebolaget SKF, Goteborg (SE)

(21) Appl. No.: 19/359,783

(22) Filed: Oct. 16, 2025

(30) Foreign Application Priority Data
Oct. 30, 2024 (DE) 102024210460.4

(51) Int. Cl. G01D 21/02

(52) U.S. Cl. CPC G01D 21/02

(57) ABSTRACT

A processing board (2) for a sensor (1) includes an interface (5) having at least a first set (5a) of terminals connected to a set of terminals (10a) of an analogic sensing board (3a) delivering an analogic signal. The interface (5) also has at least a second set (5b) of terminals connected to a set (10b) of terminals of a digital sensing board (3b) delivering a first digital signal. A processing module (6) is connected to the second set (5b) of terminals and is connected to the first set (5a) of terminals.

### CROSS-REFERENCE TO RELATED APPLICATIONS

This application claims priority to German Patent Application No. 102024210460.4, filed Oct. 30, 2024, the entirety of which is hereby incorporated by reference.

### FIELD

The present disclosure is directed to processing boards for sensors.

The present disclosure also relates to a sensor comprising a processing board and a sensing board connected to the processing board.

### BACKGROUND

Generally, a sensor comprises a processing board comprising an interface connected to a sensing board.

The sensing board may comprise a sensor delivering an analogic signal which is transmitted to a processing unit of the processing board through the interface.

The sensing board may be updated, for example by implementing a new sensor having another technology than the technology of the sensor initially implemented in the sensing board.

The new sensor may be a digital sensor delivering a digital signal.

A new processing board needs to be redesigned so that the digital signal delivered by the new sensor is transmitted to the processing unit.

Consequently, the present disclosure intends to improve the flexibility of the processing board when the sensing board is updated.

### SUMMARY

According to an aspect, a processing board for a sensor is proposed.

The processing board comprises:
an interface comprising at least a first set of terminals configured to be connected to a set of terminals of an analogic sensing board delivering an analogic signal and, at least a second set of terminals configured to be connected to a set of terminals of a digital sensing board delivering a first digital signal, and
a processing module connected to the second set of terminals and being configured to be connected to the first set of terminals.

The processing board comprising the interface is compatible with the analogic and digital sensing boards comprising sensing means delivering digital signals or analogic signals.

Preferably, the processing board further comprises a conditioning module connected to the first set of terminals and configured to be connected to the processing module, the conditioning module being configured to amplify and filter the analogic signal.

Advantageously, the processing module comprises an analogic digital converter configured to receive the filtered and amplified analogic signal delivered by the conditioning module.

Advantageously, the processing board comprises an analogic digital converter connected to the conditioning module and the processing module, and configured to convert the filtered and amplified analogic signal into an intermediary digital signal and to deliver the intermediary digital signal to the processing module.

According to a first aspect, a sensor comprising a processing board as defined above and an analogic sensing board comprising a set of terminals connected to the first set of terminals of the interface, the analogic sensing board further comprising at least first sensing means configured to deliver an analogic signal on the first set of terminals of the analogic sensing board, is proposed.

According to a second aspect, a sensor comprising a processing board as defined above and a digital sensing board comprising a set of terminals connected to the second set of terminals of the interface, the digital sensing board further comprising at least first sensing means configured to deliver a digital signal on the first set of terminals of the digital sensing board, is proposed.

Preferably, the first sensing means comprise a vibration sensor.

Accordingly, the interface further comprises a third set of terminals connected to the processing unit and to an auxiliary second set of terminals of the said sensing board, the said sensing board further comprising second sensing means configured to deliver a digital signal on the second set of terminals of the said sensing board.

Preferably, the second sensing means comprise temperature sensor.

Accordingly, the processing board comprises a wireless communication module.

Preferably, the sensor further comprises a power module to supply the processing board.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically a first example of a sensor according to the present disclosure;

FIG. 2 illustrates schematically a second example of a sensor according to the present disclosure; and

FIG. 3 illustrates schematically an example of an interface of the sensor according to the present disclosure.

### DETAILED DESCRIPTION

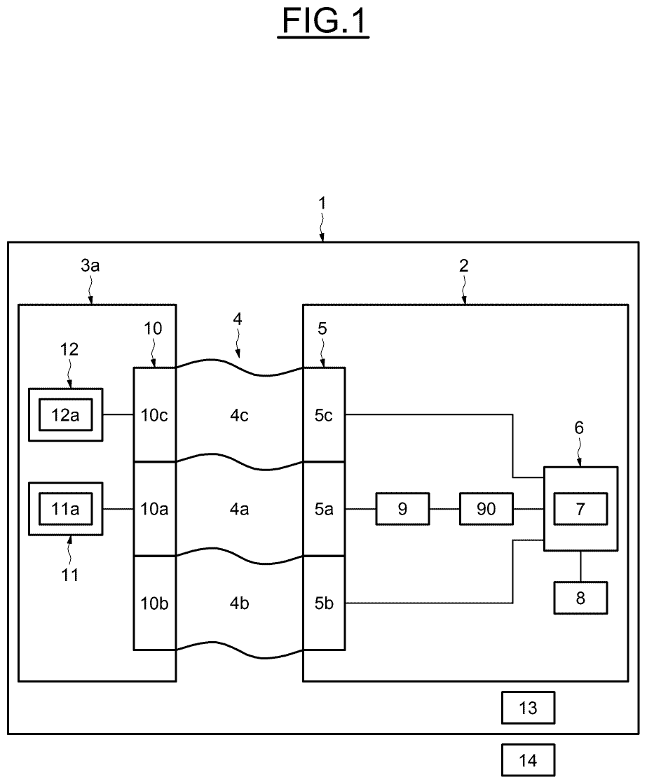

Reference is made to FIG. 1 which represents schematically a first example of a sensor 1.

The sensor 1 comprises a processing board 2 and an analogic sensing bord 3a connected to the processing board 2 with connecting means 4.

The processing board 2 comprises a first interface 5, a processing module 6 comprising a processing unit 7, a wireless communication module 8, a signal conditioning module 9 and an analogic digital converter ADC 90.

The first interface 5 comprises a first set 5a of terminals, a second set 5b of terminals and a third set 5c of terminals.

The first set 5a of terminals are connected to the signal conditioning module 9, the second set 5b of terminals and the third set 5c of terminals are connected to the processing module 6.

The ADC 90 is connected to the processing module 6 and the conditioning module 9.

The wireless communication module 8 is connected to the processing module 6.

The analogic sensing board 3a comprises a second interface 10, first sensing means 11 and second sensing means 12.

The second interface 10 comprises a first set 10a of terminals, a second set 10b of terminals and an auxiliary set 10c of terminals.

The first sensing means 11 comprise for example a vibration sensor 11a and the second sensing means 12 comprise for example a temperature sensor 12a.

The sensor 1 further comprises a power module 13 to supply the processing board 2 and the analogic sensing board 3a.

The connecting means 4 connect the first interface 5 of the processing board 2 and the second interface 10 of the processing board 3.

The connecting means 4 comprise a first sub connecting means 4a connecting the first set 5a of terminals of the first interface 5 and the first set 10a of terminals of the second interface 10, a second sub connecting means 4b connecting the second set 5b of terminals of the first interface 5 and the second set 10b of terminals of the second interface 10, and a third sub connecting means 4c connecting the third set 5c of terminals of the first interface 5 to the auxiliary set 10c of terminals of the second interface 10.

The first and second interfaces 5, 10 are identical.

The connecting means 4 comprise for example a ribbon cable.

The wireless communication module 8 is intended to communicate wirelessly with a mobile device 14.

In this example of sensor, the first sensing means 11 deliver an analogic signal for example representative of the vibrations measured by the vibration sensor 11a.

The first set 5a of terminals of the first interface 5, the first set 10a of terminals of the second interface 10 and the first sub connecting means 4a of the connecting means 4 transfer the analogic signal delivered by the first sensing means 11 to the signal conditioning module 9.

The signal conditioning module 9 amplifies and filters the analogic signal which is delivered to the ADC 90. The ADC 90 converts the filtered and amplified analogic signal into an intermediary digital signal which is delivered to the processing unit 7 of the processing module 6 for further processing. The signal conditioning module 9 is connected to the processing module 6 through the ADC 90.

The signal conditioning module 9 may comprise for example a low pass filter.

In variant, the processing board 2 does not comprise the ADC 90. The processing module 6 comprises an analogic digital converter to convert the analogic signal into the intermediary digital signal delivered to the processing unit 7.

The wireless communication module 8 may transmit the intermediary digital signal to the mobile device 14.

The third set 5c of terminals of the first interface 5, the auxiliary set 10c of terminals of the second interface 10 and the third sub connecting means 4c of the connecting means 4 transfer the digital signal delivered by the second sensing means 12 to the processing module 6 for further processing.

The wireless communication module 8 may transmit the digital signal of the second sensing means 12 to the mobile device 14.

In this example of sensor, the second set 10b of terminals of the second interface 10 is not connected for example to sensing means.

The second set 5b of terminals of the first interface 5, the second set 10b of terminals of the second interface 10 and the second sub connecting means 4b of the connecting means 4 are intended to transfer a digital signal.

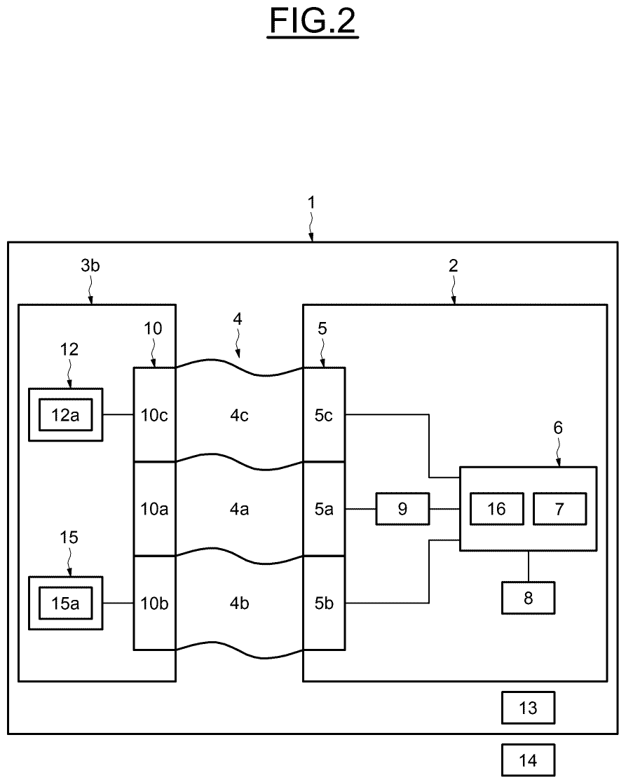

FIG. 2 represents schematically a second example of the sensor 1.

The second example of the sensor 1 differs from the first example of the sensor 1 illustrated in FIG. 1 in that the sensor 1 comprises a digital sensing board 3b connected to the processing board 2.

The digital sensing board 3b comprises the interface 10, the second sensing means 12 connected to the auxiliary set 10c of terminals of the interface 10 and first sensing means 15 delivering a digital signal.

In this example, the processing module 6 of the processing board 2 comprises an analogic digital converter 16 to convert an analogic signal delivered by the signal conditioning module 9 into a digital signal for further processing by the processing unit 7.

The processing board 2 does not comprise the ADC 90, the conditioning module 9 being directly connected to the processing module 6.

The first sensing means 15 comprise for example a vibration sensor 15a delivering the digital signal of the first sensing means 15.

The first sensing means 15 are connected to the second set 10b of terminals of the second interface 10.

The second set 5b of terminals of the first interface 5, the second set 10b of terminals of the second interface 10 and the second sub connecting means 4b of the connecting means 4 transfer the digital signal delivered by the first sensing means 15 to the processing module 6 for further processing.

The wireless communication module 8 may transmit the digital signal to the mobile device 14.

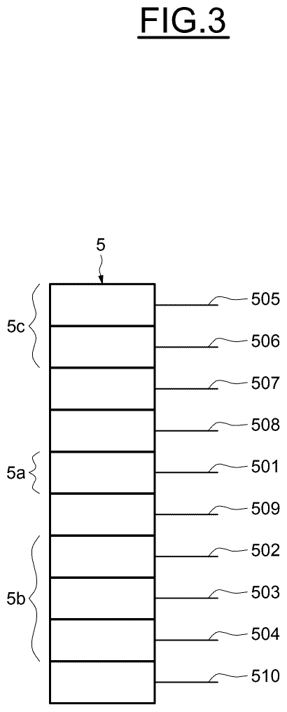

As the first and second interfaces 5, 10 are identical, FIG. 3 represents schematically an example of the first interface 5.

In this example, the first set 5a of terminals comprise a plurality of terminals 501.

The second set 5b of terminals comprise three terminals 502, 503, 504 forming for example a serial peripheral interface SPI. A first terminal 502 transfers for example a serial clock signal, a second terminal 503 transfers for example the master output, slave input MOSI signal and a third terminal 504 transfers for example the master input, slave output MISO signal.

The third set 5c of terminals comprise two terminals 505, 506 forming for example an inter-integrated circuit I²C interface. A first terminal 505 transfers for example a clock signal SCL and a second terminal 506 transfers for example a data signal SDA.

The terminals 507, 510 are for example connected to the power module to supply the sensing means 11, 12, 15 and the terminals 508, 509 are for example connected to a common mass of the sensor 1.

The processing board 2 comprising the interface 5 is compatible with the analogic and digital sensing boards 3a, 3b comprising sensing means delivering digital signals or analogic signals.

When the sensing means are updated, for example updating sensing means from sensing means delivering analogic signals and may be digital signals to sensing means delivering only digital signals, only the sensing board need to be redesigned, the processing board 2 being configured to interact with the initial sensing board and the redesigned sensing board. The development of an updated sensor comprising the updated sensing board is simplified, reducing costs and time of development.

What is claimed is:

1. A processing board for a sensor, the processing board comprising:
an interface comprising a first set of terminals configured to be connected to a set of terminals of an analogic sensing board delivering an analogic signal and a second set of terminals configured to be connected to a set of terminals of a digital sensing board delivering a first digital signal; and
a processing module connected to the second set of terminals and being configured to be connected to the first set of terminals.

2. The processing board according to claim 1, further comprising a conditioning module connected to the first set of terminals and configured to be connected to the processing module, the conditioning module being configured to amplify and filter the analogic signal.

3. The processing board according to claim 2, wherein the processing module comprises an analogic digital converter configured to receive the filtered and amplified analogic signal delivered by the conditioning module.

4. The processing board according to claim 2, further comprising an analogic digital converter connected to the conditioning module and the processing module, and configured to convert the filtered and amplified analogic signal into an intermediary digital signal and to deliver the intermediary digital signal to the processing module.

5. A sensor comprising:
the processing board according to claim 1; and
the analogic sensing board, the analogic sensing board comprising a set of terminals connected to the first set of terminals of the interface, the analogic sensing board further comprising a first sensing means configured to deliver an analogic signal on the set of terminals of the analogic sensing board.

6. The sensor according to claim 5, wherein the first sensing means comprises a vibration sensor.

7. The sensor according to claim 5, wherein the interface further comprises a third set of terminals connected to the processing unit and to an auxiliary set of terminals of the sensing board, the sensing board further comprising a second sensing means configured to deliver a digital signal on the second set of terminals of the sensing board.

8. The sensor according to claim 7, wherein the second sensing means comprises a temperature sensor.

9. The sensor according to claim 5, wherein the processing board comprises a wireless communication module.

10. The sensor according to claim 6, wherein:
the interface further comprises a third set of terminals connected to the processing unit and to an auxiliary set of terminals of the sensing board;
the sensing board further comprises a second sensing means configured to deliver a digital signal on the second set of terminals of the sensing board; and
the processing board comprises a wireless communication module.

11. The sensor according to claim 10, wherein the second sensing means comprises a temperature sensor.

12. A sensor comprising:
the processing board according to claim 1; and
the digital sensing board, the digital sensing board comprising a set of terminals connected to the second set of terminals of the interface, the sensing board further comprising a first sensing means configured to deliver a digital signal on the set of terminals of the digital sensing board.

13. The sensor according to claim 12, wherein the first sensing means comprises a vibration sensor.

14. The sensor according to claim 12, wherein the interface further comprises a third set of terminals connected to the processing unit and to an auxiliary set of terminals of the sensing board, the sensing board further comprising a second sensing means configured to deliver a digital signal on the second set of terminals of the sensing board.

15. The sensor according to claim 14, wherein the second sensing means comprises a temperature sensor.

16. The sensor according to claim 12, wherein the processing board comprises a wireless communication module.

17. The sensor according to claim 13, wherein:
the interface further comprises a third set of terminals connected to the processing unit and to an auxiliary set of terminals of the sensing board;
the sensing board further comprises a second sensing means configured to deliver a digital signal on the second set of terminals of the sensing board; and
the processing board comprises a wireless communication module.

18. The sensor according to claim 17, wherein the second sensing means comprises a temperature sensor.
